(19) United States
(12) Patent Application Publication
(10) Pub. No.: US 2022/0374822 A1
(43) Pub. Date: Nov. 24, 2022

(54) PROCESS SPECIFIC ANTIPATTERNS DETERMINATION IN SUPPLY CHAIN

(71) Applicant: International Business Machines Corporation, Armonk, NY (US)

(72) Inventors: Himangshu Mech, Nazira (IN); Sudhanshu Sekher Sar, Bangalore (IN); Shephil Graceline Philip, Bangalore (IN); Aishwarya Saraswathi H M, Bangalore (IN)

(21) Appl. No.: 17/324,519

(22) Filed: May 19, 2021

(51) Int. Cl. G06Q 10/08; G06N 20/00

(52) U.S. Cl. CPC G06Q 10/087; G06N 20/00

(57) ABSTRACT

Technology for machine logic (that is, computer software, computer hardware) to perform a process that: (i) receives historical data relating to historical operations of a supply chain; (ii) applies a machine learning algorithm to detect that an antipattern exists inherent in the way the supply chain is being operated; (iii) calculates a bias influence score based on the existing antipattern; (iv) re-applies the machine learning algorithm to identify a discovered anomaly that exists in historical data relating to operation of the supply chain; and (v) sends out a communication identifying the discovered anomaly.

### BACKGROUND

The present invention relates generally to the field of supply chains, and also to particularly to antipatterns.

The Wikipedia entry for “Supply Chain” (as of Feb. 22, 2021) states as follows: “In commerce, a supply chain is a system of organizations, people, activities, information, and resources involved in supplying a product or service to a consumer. Supply chain activities involve the transformation of natural resources, raw materials, and components into a finished product that is delivered to the end customer. In sophisticated supply chain systems, used products may re-enter the supply chain at any point where residual value is recyclable. Supply chains link value chains. A typical supply chain begins with the ecological, biological, and political regulation of natural resources, followed by the human extraction of raw material, and includes several production links (e.g., component construction, assembly, and merging) before moving on to several layers of storage facilities of ever-decreasing size and increasingly remote geographical locations, and finally reaching the consumer.” (footnote(s) omitted)

The Wikipedia entry for “Antipatterns” (as of Feb. 22, 2021) states as follows: “An antipattern is a common response to a recurring problem that is usually ineffective and risks being highly counterproductive . . . . The term was popularized [when its use was] extended its use beyond the field of software design to refer informally to any commonly reinvented but bad solution to a problem. Examples include analysis paralysis, cargo cult programming, death march, groupthink and vendor lock-in.” (footnote(s) omitted)

### SUMMARY

According to an aspect of the present invention, there is a method, computer program product and/or system that performs the following operations (not necessarily in the following order): (i) receive historical data relating to historical operations of a supply chain; (ii) receive antipattern data defining a plurality of antipatterns, including a first antipattern; (iii) apply a machine learning algorithm to detect that the first antipattern is inherent in the way the supply chain is being operated based on the historical data and the antipattern data; (iv) calculate a bias influence score based on the first antipattern; (v) apply the bias influence score as feedback to the machine learning algorithm to obtain a refined machine learning algorithm; and (vi) apply the refined machine learning algorithm to detect a first anomaly that exists in the historical data.

### BRIEF DESCRIPTION OF THE DRAWINGS

FIG. 1 is a block diagram view of a first embodiment of a system according to the present invention;

FIG. 2 is a flowchart showing a first embodiment method performed, at least in part, by the first embodiment system;

FIG. 3 is a block diagram showing a machine logic (for example, software) portion of the first embodiment system;

FIG. 4 is a graph showing a supply chain that is analyzed by the first embodiment system; and

FIG. 5 is a flowchart according to a second embodiment of a method the present invention.

### DETAILED DESCRIPTION

This Detailed Description section is divided into the following subsections: (i) The Hardware and Software Environment; (ii) Example Embodiment; (iii) Further Comments and/or Embodiments; and (iv) Definitions.

### I. The Hardware and Software Environment

The present invention may be a system, a method, and/or a computer program product at any possible technical detail level of integration. The computer program product may include a computer readable storage medium (or media) having computer readable program instructions thereon for causing a processor to carry out aspects of the present invention. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (for example, light pulses passing through a fiber-optic cable), or electrical signals transmitted through a wire.

A “storage device” is hereby defined to be anything made or adapted to store computer code in a manner so that the computer code can be accessed by a computer processor. A storage device typically includes a storage medium, which is the material in, or on, which the data of the computer code is stored. A single “storage device” may have: (i) multiple discrete portions that are spaced apart, or distributed (for example, a set of six solid state storage devices respectively located in six laptop computers that collectively store a single computer program); and/or (ii) may use multiple storage media (for example, a set of computer code that is partially stored in as magnetic domains in a computer's non-volatile storage and partially stored in a set of semiconductor switches in the computer's volatile memory). The term “storage medium” should be construed to cover situations where multiple different types of storage media are used.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

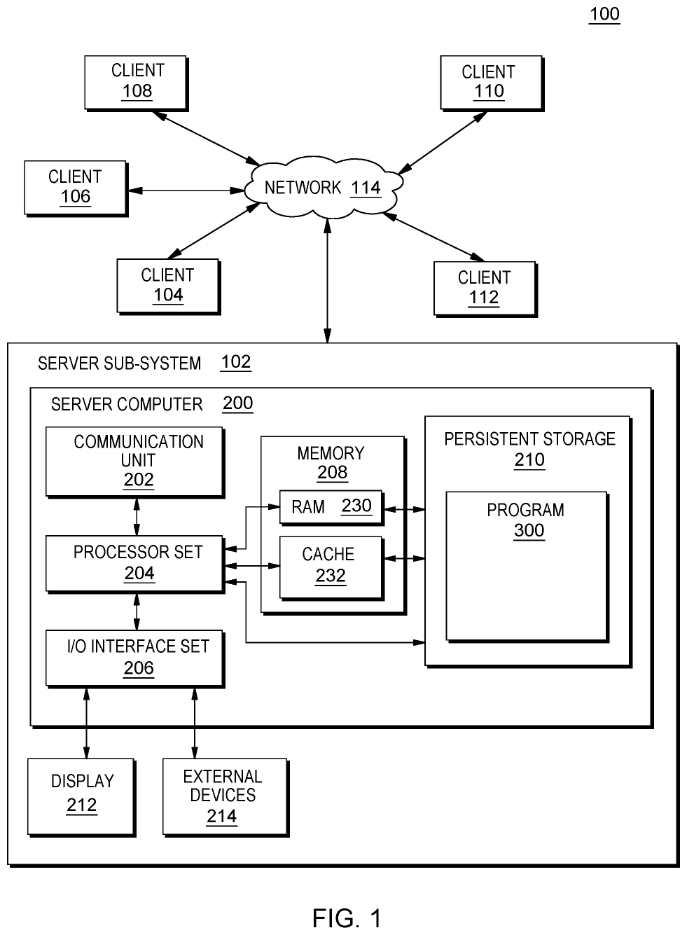

As shown in FIG. 1, networked computers system 100 is an embodiment of a hardware and software environment for use with various embodiments of the present invention. Networked computers system 100 includes: server subsystem 102 (sometimes herein referred to, more simply, as subsystem 102); client subsystems 104, 106, 108, 110, 112; and communication network 114. Server subsystem 102 includes: server computer 200; communication unit 202; processor set 204; input/output (I/O) interface set 206; memory 208; persistent storage 210; display 212; external device(s) 214; random access memory (RAM) 230; cache 232; and program 300.

Subsystem 102 may be a laptop computer, tablet computer, netbook computer, personal computer (PC), a desktop computer, a personal digital assistant (PDA), a smart phone, or any other type of computer (see definition of “computer” in Definitions section, below). Program 300 is a collection of machine readable instructions and/or data that is used to create, manage and control certain software functions that will be discussed in detail, below, in the Example Embodiment subsection of this Detailed Description section.

Subsystem 102 is capable of communicating with other computer subsystems via communication network 114. Network 114 can be, for example, a local area network (LAN), a wide area network (WAN) such as the Internet, or a combination of the two, and can include wired, wireless, or fiber optic connections. In general, network 114 can be any combination of connections and protocols that will support communications between server and client subsystems.

Subsystem 102 is shown as a block diagram with many double arrows. These double arrows (no separate reference numerals) represent a communications fabric, which provides communications between various components of subsystem 102. This communications fabric can be implemented with any architecture designed for passing data and/or control information between processors (such as microprocessors, communications and network processors, etc.), system memory, peripheral devices, and any other hardware components within a computer system. For example, the communications fabric can be implemented, at least in part, with one or more buses.

Memory 208 and persistent storage 210 are computer-readable storage media. In general, memory 208 can include any suitable volatile or non-volatile computer-readable storage media. It is further noted that, now and/or in the near future: (i) external device(s) 214 may be able to supply, some or all, memory for subsystem 102; and/or (ii) devices external to subsystem 102 may be able to provide memory for subsystem 102. Both memory 208 and persistent storage 210: (i) store data in a manner that is less transient than a signal in transit; and (ii) store data on a tangible medium (such as magnetic or optical domains). In this embodiment, memory 208 is volatile storage, while persistent storage 210 provides nonvolatile storage. The media used by persistent storage 210 may also be removable. For example, a removable hard drive may be used for persistent storage 210. Other examples include optical and magnetic disks, thumb drives, and smart cards that are inserted into a drive for transfer onto another computer-readable storage medium that is also part of persistent storage 210.

Communications unit 202 provides for communications with other data processing systems or devices external to subsystem 102. In these examples, communications unit 202 includes one or more network interface cards. Communications unit 202 may provide communications through the use of either or both physical and wireless communications links. Any software modules discussed herein may be downloaded to a persistent storage device (such as persistent storage 210) through a communications unit (such as communications unit 202).

I/O interface set 206 allows for input and output of data with other devices that may be connected locally in data communication with server computer 200. For example, I/O interface set 206 provides a connection to external device set 214. External device set 214 will typically include devices such as a keyboard, keypad, a touch screen, and/or some other suitable input device. External device set 214 can also include portable computer-readable storage media such as, for example, thumb drives, portable optical or magnetic disks, and memory cards. Software and data used to practice embodiments of the present invention, for example, program 300, can be stored on such portable computer-readable storage media. I/O interface set 206 also connects in data communication with display 212. Display 212 is a display device that provides a mechanism to display data to a user and may be, for example, a computer monitor or a smart phone display screen.

In this embodiment, program 300 is stored in persistent storage 210 for access and/or execution by one or more computer processors of processor set 204, usually through one or more memories of memory 208. It will be understood by those of skill in the art that program 300 may be stored in a more highly distributed manner during its run time and/or when it is not running. Program 300 may include both machine readable and performable instructions and/or substantive data (that is, the type of data stored in a database). In this particular embodiment, persistent storage 210 includes a magnetic hard disk drive. To name some possible variations, persistent storage 210 may include a solid state hard drive, a semiconductor storage device, read-only memory (ROM), erasable programmable read-only memory (EPROM), flash memory, or any other computer-readable storage media that is capable of storing program instructions or digital information.

The programs described herein are identified based upon the application for which they are implemented in a specific embodiment of the invention. However, it should be appreciated that any particular program nomenclature herein is used merely for convenience, and thus the invention should not be limited to use solely in any specific application identified and/or implied by such nomenclature.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

### II. Example Embodiment

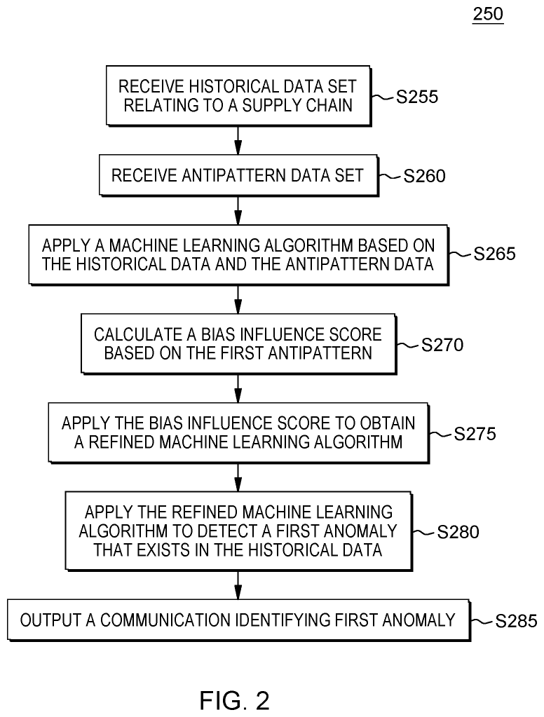

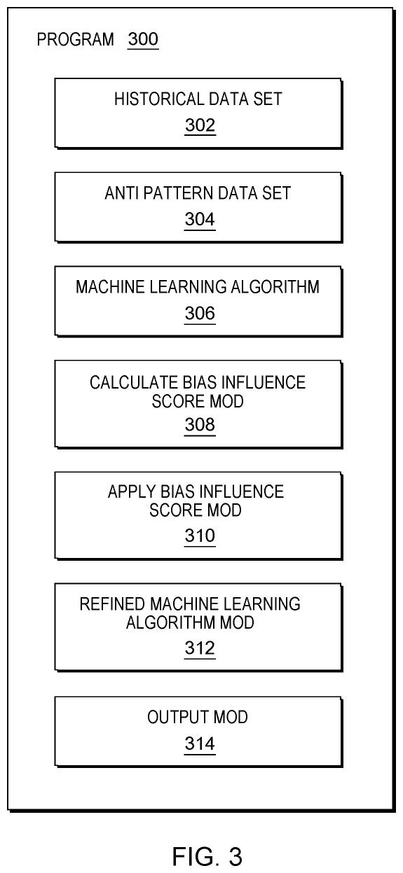

As shown in FIG. 1, networked computers system 100 is an environment in which an example method according to the present invention can be performed. As shown in FIG. 2, flowchart 250 shows an example method according to the present invention. As shown in FIG. 3, program 300 performs or controls performance of at least some of the method operations of flowchart 250. This method and associated software will now be discussed, over the course of the following paragraphs, with extensive reference to the blocks of FIGS. 1, 2 and 3.

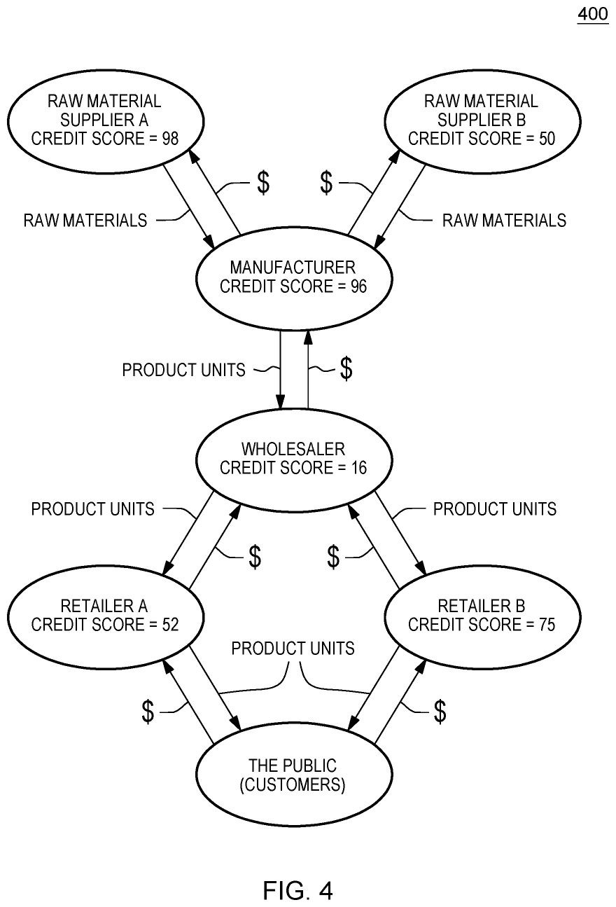

Processing begins at operation S255, where historical data set 302 is received from client sub-system 104 through network 114. Historical data set 302 relates to historical operations of a supply chain. Graph 400 of FIG. 4 shows an example of a supply chain to which the method of flowchart 250 may be applied. The nodes of graph 400 represent entities (typically companies, individuals or groups of individuals). More specifically, in this example, each node includes the following information: (i) entity name; (ii) current entity credit score; (iii) entity credit score history; and (iv) previous anti-pattern history for the entity. The edges of graph 400 represent the transactions between each pair of entities connected by an edge. More specifically, in this example, each edge of graph 400 includes the following information: (i) amounts and dates of payments between the entities connected by the edge; (ii) amounts and dates of exchanges of products/goods/services between the connected entities; (iii) any executory supply contracts; and (iv) dependencies between the suppliers.

Processing proceeds to operation S260 where antipattern data set 304 is received from client sub-system 106 through network 114. This antipattern data set 304 provides instructions, relevant parameters and/or thresholds that define multiple antipattern definitions. Each given definition of an antipattern provide the standards used to determine when a given real world situation/context/series of transactions evinces the antipattern that is defined by the given definition. In this example, there are six (6) antipattern definitions as follows: (i) analysis paralysis; (ii) cargo cult programming; (iii) death march; (iv) groupthink; (v) vendor lock-in; and (vi) relevant anti-patterns include, but are not limited to: (a) bad leadership, (b) cash cow, and (c) scope creep.

Processing proceeds to operation S265 where machine learning algorithm 306 is applied to the historical data and the antipattern data. In this case, the machine algorithm includes but is not limited to anomaly detection algorithms for multivariate data—self-organizing maps.

Processing proceeds to operation S270 where calculate bias influence score mod 308 calculates a bias influence score based on the first antipattern, which, in this case is the death march antipattern. Because the death march antipattern is determined to be strongly manifested in the supply chain of graph 400, this bias influence score is a 6.00, which is relatively large given the scaling applied to bias influence scores in the present example.

Processing proceeds to operation S275 where apply bias influence score mod 310 applies the bias influence score to obtain a refined machine learning algorithm 312.

Processing proceeds to operation S280 where refined machine learning algorithm mod 312 is applied to detect a first anomaly that exists in the historical data. This anomaly is identified primarily because of the counter death march antipattern revisions made to the algorithm at previous operation S275.

Processing proceeds to operation S285 where output mod 314 outputs a communication identifying first anomaly.

Some embodiments of the present invention may include one, or more, of the following operations, features, characteristics and/or advantages: (i) determining associated supply chain processes and workflows that are in scope; (ii) determining transformation factors, such as efficiency, modernization, and strategy; (iii) determining operational factors (which could be applied through, but not limited to, one or more of the following transformation types in the areas of digital, AI (artificial intelligence), and cloud transformations): (a) business model efficiency, (b) application modernization, and (c) data-driven strategy; and/or (iv) computing the influence score of transformation operations on each supply chain process and underlying workflows.

Some embodiments of the present invention may include one, or more, of the following operations, features, characteristics and/or advantages: (i) determining associated supply chain processes and workflows that are in scope; (ii) determining transformation factors such as efficiency, modernization, and strategy where these factors could be applied through one or more of the following transformation types in the areas of digital, AI (artificial intelligence), and cloud transformations: (a) business model efficiency, (b) application modernization, and/or (c) data-driven strategy; (iii) determining operational factors such as value, agility, and efficiency where these factors could be applied through one or more of the following operation types in the areas of business and IT (information technology) operations: (a) business strategy: (1) product differentiation and value-based services strategy, and/or (2) knowledge of the latest business trends to stay relevant, (b) marketing and merchandising: (1) efficacy in internet and email marketing, and/or (2) transparency in vendor selection, and/or (c) finance and legal: (1) transparency in auditing and cash flow management, (2) agility in resource allocation, and/or (3) knowledge of geo-based regulation; and/or (iv) computing the influence score of transformation operations on each supply chain process and underlying workflows.

### III. Further Comments and/or Embodiments

Some embodiments of the present invention recognize the following facts, potential problems and/or potential areas for improvement with respect to the current state of the art: (i) antipatterns are bad practices that should be avoided in solution development; (ii) while antipattern benefits are predominately realized in software development, it has also been found some in the supply chain footprint; (iii) antipattern benefits are limited to organization, management and software; (iv) supply chain, as domain comprises business capabilities, are driven by multiple discrete process-oriented workflows and varies across industries; (v) business capability-oriented processes experience periodic amendments for every major shift in business strategy; (vi) while a business strategy is driven through both operations and transformations, they heavily influence the underlying business capabilities; (vii) lack of alignment between operations, transformations and business capability-oriented processes often negatively impact the defining of business strategy; (viii) presently there are no antipatterns established in supply chain processes and workflows; and/or (ix) there is a need for a system and method to derive patterns from repetitive pitfalls which share commonalities among them in the context of industry vertical models and associated business models.

A method according to an embodiment of the present invention includes the following operations (not necessarily in the following order): (i) establishing antipatterns in the supply chain process by factoring discrete dimensions of transformation and operations (in the context of industry vertical models and business models); (ii) computing the influence score of transformation and operations in the context of industry and business models; and (iii) factoring in the influence score as bias in feedback learning (for a supply chain process).

Some embodiments of the present invention may include one, or more, of the following operations, features, characteristics and/or advantages: (i) establishes the antipattern based on the business capabilities in a supply chain process; (ii) factors the industry vertical model along with discrete dimensions of transformation and operation; (iii) factors the bias in feedback learning while computing the influence of the transformation and operation factors for an industry vertical model; (iv) determines the supply chain process specific antipatterns using anomaly detection and scoring methods through dimension factorization and influence computation of transformation and operation aspects in the context of industry vertical models and business models; and/or (v) determines the repetitive anomalies in the supply chain process by factoring the influence score of transformation and operation as bias in feedback learning.

Some embodiments of the present invention may include one, or more, of the following operations, features, characteristics and/or advantages: (i) defines a procedure to determine the antipatterns in the supply chain processes; (ii) features a system which could establish the antipatterns for supply chain for business models and industry vertical models by factoring in the operations and transformation dimensions; and/or (iii) computes the influence of the transformation and operation factors for an industry vertical model by factoring in the bias in feedback learning.

Some embodiments of the present invention may include one, or more, of the following operations, features, characteristics and/or advantages: (i) includes systems and factors to determine the antipattern in the supply chain process; (ii) computes the influence score of the supply chain dimensions and feedback learning; (iii) includes a system to establish the supply chain process specific antipattern; (iv) considers the factors specific to industries and the business models; (v) considers the dimensions of transformation and operations in establishing the antipattern; (vi) computes the influence score in the context of the industry and business models to factor the bias in feedback learning for antipattern determination; and/or (vii) determines the antipattern for a specific supply chain process.

Some embodiments of the present invention may include one, or more, of the following operations, features, characteristics and/or advantages: (i) establishes the antipatterns in the supply chain process; (ii) uses feedback learning to enhance the antipattern determination process using past data; (iii) describes a system which could establish potential antipatterns in the supply chain process; (iv) factors in the transformation and the operational dimensions; (v) factors in the industry vertical model and business model context to maintain an advantage in the field of antipattern determination; and/or (vi) computes an influence score of transformation and the operations by adding the industry and the business model context to factor in bias in the feedback learning process.

Some embodiments of the present invention may include one, or more, of the following operations, features, characteristics and/or advantages: (i) applies the associated supply chain processes and workflows to factor the discrete dimensions of transformation and operations to determine the supply chain specific antipatterns; (ii) includes transformation and operation dimensions in the context of the business model and the industry vertical model to establish the antipatterns; (iii) includes the ability to establish antipatterns in the supply chain processes and workflows; (iv) computes the influence score of the transformation and the operation aspects in the context of the industry and business model; (v) includes feedback learning for determining the antipatterns in the supply chain; and/or (vi) adapts to the evolving supply chain processes and its workflow to determine the antipatterns.

Some embodiments of the present invention may include one, or more, of the following operations, features, characteristics and/or advantages: (i) can be applied to industry and related business models (for example: industry—retail, oil & gas etc., business model—B2B (business-to-business), B2C (business-to-consumer)); (ii) determines the associated supply chain processes and workflows in scope; (iii) determines the transformation factors and the operational factors; (iv) computes the influence score of transformation plus the operations on each supply chain process and underlying workflows; and/or (v) uses machine learning to determine repetitive anomalies during the supply chain execution process by factoring in the influence score as bias in feedback learning.

Some embodiments of the present invention may include one, or more, of the following operations, features, characteristics and/or advantages: (i) in the context of industry vertical models and business models, establishes antipatterns in the supply chain process by factoring discrete dimensions of transformation and operation; and/or (ii) for a supply chain process, computes the influence score of transformation plus operations in the context of industry and business models by factoring in bias in feedback learning.

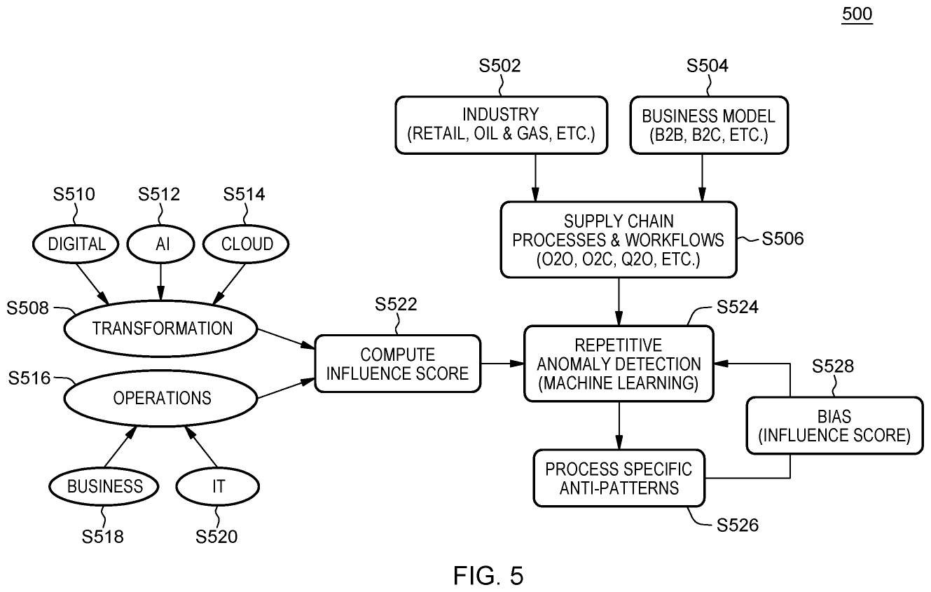

As shown in FIG. 5, flowchart 500 includes: industry (retail, oil and gas, etc.) block S502; business model (B2B (business-to-business), B2C (business-to-consumer), etc.) block S504; supply chain processes and workflows (O2O (online-to-offline), O2C (order-to-cash), Q2O (quote-to-order), etc.) block S506; transformation block S508; IoT/digital block S510; AI (artificial intelligence) block S512; cloud block S514; operations block S516; business block S518; IT (information technology) block S520; compute influence score block S522; repetitive anomaly detection (machine learning) block S524; process specific antipatterns block S526; and bias (influence score) block S528.

Some embodiments of the present invention are described in the following four (4) paragraphs with reference to FIG. 5, flowchart 500.

The first step, for a given industry (operation S502) and related business models (operation S504), is to determine the associated supply chain processes and workflows in scope:

Supply chain processes SCPH=determineSCProcesses( )
Workflow WF[ ]=determineworkFlow( )

The second step is to determine the transformation factors (operation S508) and the operational factors (operation S516). The transformation factors (operation S508) include: (i) infrastructure upgrade; (ii) migration (legacy system); and (iii) new technology adoption (IoT/digital (operation S510)), AI (operation S512), and cloud (operation S514). Operational factors (operation S516) include: (i) business operations (operation S518); and (ii) IT operations (operation S520).

The third step computes the influence score of transformation plus operations (operation S522) on each supply chain process and underlying workflows. For each supply chain process and underlying workflow, the following is determined:

Influence Score IS H=determineInfluenceScore (transformation factors, operational factors)

Finally, the last step is to use machine learning (operation S524) to determine repetitive anomalies during the supply chain process execution (operation S526) by factoring the influence score as bias (operation S528) using feedback learning back to repetitive anomaly detection (machine learning) (operation S524).

### IV. Definitions

Present invention: should not be taken as an absolute indication that the subject matter described by the term “present invention” is covered by either the claims as they are filed, or by the claims that may eventually issue after patent prosecution; while the term “present invention” is used to help the reader to get a general feel for which disclosures herein are believed to potentially be new, this understanding, as indicated by use of the term “present invention,” is tentative and provisional and subject to change over the course of patent prosecution as relevant information is developed and as the claims are potentially amended.

Embodiment: see definition of “present invention” above—similar cautions apply to the term “embodiment.”

and/or: inclusive or; for example, A, B “and/or” C means that at least one of A or B or C is true and applicable.

Including/include/includes: unless otherwise explicitly noted, means “including but not necessarily limited to.”

Module/Sub-Module: any set of hardware, firmware and/or software that operatively works to do some kind of function, without regard to whether the module is: (i) in a single local proximity; (ii) distributed over a wide area; (iii) in a single proximity within a larger piece of software code; (iv) located within a single piece of software code; (v) located in a single storage device, memory or medium; (vi) mechanically connected; (vii) electrically connected; and/or (viii) connected in data communication.

Computer: any device with significant data processing and/or machine readable instruction reading capabilities including, but not limited to: desktop computers, mainframe computers, laptop computers, field-programmable gate array (FPGA) based devices, smart phones, personal digital assistants (PDAs), body-mounted or inserted computers, embedded device style computers, application-specific integrated circuit (ASIC) based devices.

What is claimed is:

1. A computer-implemented method (CIM) comprising:
receive historical data relating to historical operations of a supply chain;
receive antipattern data defining a plurality of antipatterns, including a first antipattern;
apply a machine learning algorithm to detect that the first antipattern is inherent in the way the supply chain is being operated based on the historical data and the antipattern data;
calculate a bias influence score based on the first antipattern;
apply the bias influence score as feedback to the machine learning algorithm to obtain a refined machine learning algorithm; and
apply the refined machine learning algorithm to detect a first anomaly that exists in the historical data.

2. The CIM of claim 1 further comprising:
sending out, over a communication network and to a first recipient device, a communication identifying the first anomaly.

3. The CIM of claim 1 wherein the first antipattern is one of the following types of antipattern: analysis paralysis, cargo cult programming, death march, groupthink or vendor lock-in.

4. The CIM of claim 1 further comprising:
determining associated supply chain processes and workflows that are in scope.

5. The CIM of claim 1 further comprising:
determining transformation factors and operational factors.

6. The CIM of claim 1 further comprising:
computing the influence score of transformation operations on each supply chain process and underlying workflows.

7. A computer program product (CPP) comprising:
a set of storage device(s); and
computer code stored collectively in the set of storage device(s), with the computer code including data and instructions to cause a processor(s) set to perform at least the following operations:
receive historical data relating to historical operations of a supply chain,
receive antipattern data defining a plurality of antipatterns, including a first antipattern,
apply a machine learning algorithm to detect that the first antipattern is inherent in the way the supply chain is being operated based on the historical data and the antipattern data,
calculate a bias influence score based on the first antipattern,
apply the bias influence score as feedback to the machine learning algorithm to obtain a refined machine learning algorithm, and
apply the refined machine learning algorithm to detect a first anomaly that exists in the historical data.

8. The CPP of claim 7 wherein the computer code further includes instructions for causing the processor(s) set to perform the following operation(s):
sending out, over a communication network and to a first recipient device, a communication identifying the first anomaly.

9. The CPP of claim 7 wherein the first antipattern is one of the following types of antipattern: analysis paralysis, cargo cult programming, death march, groupthink or vendor lock-in.

10. The CPP of claim 7 wherein the computer code further includes instructions for causing the processor(s) set to perform the following operation(s):
determining associated supply chain processes and workflows that are in scope.

11. The CPP of claim 7 wherein the computer code further includes instructions for causing the processor(s) set to perform the following operation(s):
determining transformation factors and operational factors.

12. The CPP of claim 7 wherein the computer code further includes instructions for causing the processor(s) set to perform the following operation(s):
computing the influence score of transformation operations on each supply chain process and underlying workflows.

13. A computer system (CS) comprising:
a processor(s) set;
a set of storage device(s); and
computer code stored collectively in the set of storage device(s), with the computer code including data and instructions to cause the processor(s) set to perform at least the following operations:
receive historical data relating to historical operations of a supply chain,
receive antipattern data defining a plurality of antipatterns, including a first antipattern,
apply a machine learning algorithm to detect that the first antipattern is inherent in the way the supply chain is being operated based on the historical data and the antipattern data,
calculate a bias influence score based on the first antipattern,
apply the bias influence score as feedback to the machine learning algorithm to obtain a refined machine learning algorithm, and
apply the refined machine learning algorithm to detect a first anomaly that exists in the historical data.

14. The CS of claim 13 wherein the computer code further includes instructions for causing the processor(s) set to perform the following operation(s):
sending out, over a communication network and to a first recipient device, a communication identifying the first anomaly.

15. The CS of claim 13 wherein the first antipattern is one of the following types of antipattern: analysis paralysis, cargo cult programming, death march, groupthink or vendor lock-in.

16. The CS of claim 13 wherein the computer code further includes instructions for causing the processor(s) set to perform the following operation(s):
determining associated supply chain processes and workflows that are in scope.

17. The CS of claim 13 wherein the computer code further includes instructions for causing the processor(s) set to perform the following operation(s):
determining transformation factors and operational factors.

18. The CS of claim 13 wherein the computer code further includes instructions for causing the processor(s) set to perform the following operation(s):
computing the influence score of transformation operations on each supply chain process and underlying workflows.
